(19) United States
(12) Patent Application Publication
(10) Pub. No.: US 2019/0204718 A1
(43) Pub. Date: Jul. 4, 2019

(54) ONE OR MORE CAMERA MOUNTS FOR A RADAR GUN ASSEMBLY

(71) Applicant: Hollywood South Digital Post, Inc., Gresham, OR (US)

(72) Inventor: Jerry Lowell Kelley, Gresham, OR (US)

(21) Appl. No.: 16/236,241

(22) Filed: Dec. 28, 2018

Related U.S. Application Data
(63) Continuation-in-part of application No. 15/859,302, filed on Dec. 29, 2017.

(51) Int. Cl. G03B 17/56; H04N 5/445; H04M 1/04; H04M 1/725; G01S 13/86

(52) U.S. Cl. CPC G03B 17/561; H04N 5/44504; H04N 5/4403; H04M 1/72527; G01S 13/867; H04M 1/04

(57) ABSTRACT

Briefly, embodiments of one or more mounts for a radar gun assembly are disclosed. For example, a radar gun mount is to detachably attach a portable computing device that includes video imaging capability to a radar gun in a manner so that the portable computing device is able to capture a scene as radar gun measurements related to the scene are to be concurrently generated. The portable computing device is to be attached to the radar gun mount. The portable computing device and the radar gun are to be able to communicate so that the portable computing device is to be further capable to generate a composite of content formed from video imaging captured by the portable computing device and the radar gun measurements related to the scene that are to be concurrently generated.

### CROSS-REFERENCE TO RELATED APPLICATIONS

This patent application is a continuation-in-part of U.S. patent application Ser. No. 15/859,302, entitled “ONE OR MORE CAMERA MOUNTS FOR A RADAR GUN ASSEMBLY”, which was filed on Dec. 29, 2017 and also claims the benefit of and priority to concurrently filed U.S. Design Patent Application Ser. No. 29/631,491, entitled “CAMERA MOUNTS FOR RADAR GUN ASSEMBLY” filed on Dec. 29, 2017; this application also claims the benefit of and priority to concurrently filed U.S. Design Patent Application Ser. No. 29/675,238, entitled “CAMERA MOUNT FOR RADAR GUN ASSEMBLY” filed on Dec. 28, 2018, all of the foregoing patent applications, in their entirety, being herein incorporated by reference and being assigned to the assignee of currently claimed subject matter.

### BACKGROUND

### 1. Field

Subject matter disclosed herein relates to one or more camera mounts for a radar gun assembly, such as one or more camera mounts for a portable (e.g., hand-held) computing device that includes a capability to generate video images.

### 2. Information

Athletes, such as baseball players, are sometimes videotaped, for example, so their athletic performance may be evaluated. A baseball pitcher, for example, may be videotaped, such as while pitching during a baseball game, at practice by a coach, by the pitcher's family and/or friends, by a baseball scout, etc., to name just a few examples. For example, a pitcher's throwing motion may be evaluated using a video recording of one or more pitches.

Likewise, as part of an evaluation of a pitcher's performance, various parameters (e.g., performance-related parameters) may be measured independently from a video recording. For example, a radar gun may be utilized to measure ball velocity with respect to baseballs thrown by a pitcher. Other types of parameters may also (or alternatively) be measured. Examples include time interval between pitches, speed of a pitchers' windup, a spin rate of a pitch, etc., to name just a few examples. Similarly, performance-related parameters for baseball players other than a pitcher may be measured. For example, a length of time and/or a speed at which a baserunner runs between one or more bases, such as after hitting a baseball, while stealing a base, etc., may be measured. Likewise, a baseball hitter's bat speed and/or velocity of a baseball after being hit may be measured, as further examples. Any and all of the foregoing, separately or in combinations, may be measured. Likewise, other types of performance-related parameters for other activities, including other types of sports, may be measured.

Thus, an athlete may be able to evaluate his or her performance (and/or have his or her performance evaluated by another) if video and performance-related parameter measurements are able to be made readily available.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a sketch of an image illustrating an embodiment of a main camera;

FIG. 2 is a sketch of an image illustrating an embodiment of a sub-camera;

FIGS. 3A and 3B are sketches of images of different views illustrating an embodiment of a radar gun;

FIG. 3C is a sketch of an image illustrating an embodiment of an output display of a radar gun embodiment;

FIG. 4A is a sketch illustrating an exploded view of an embodiment of assembly comprising a radar gun embodiment, a main camera embodiment, and a sub-camera embodiment;

FIG. 4B is a sketch of an image illustrating a front perspective view of the embodiment of FIG. 4A after being assembled;

FIG. 4C is a sketch of an image illustrating a side view of the embodiment of FIG. 4A after being assembled;

FIG. 5 is a sketch of an image illustrating an embodiment of an electronic connector component for an embodiment of an assembly;

FIG. 6 is a sketch of an image illustrating an embodiment of a radar gun and an embodiment of a sub-camera mount;

FIGS. 7A and 7B are sketches of images showing different perspective views of an embodiment of a sub-camera mount;

FIGS. 8A-C are sketches of images illustrating various views of another embodiment of a sub-camera mount;

FIG. 9 is a sketch illustrating an embodiment of a plate to be coupled to a bottom portion of an embodiment of a main camera;

FIGS. 10A and 10B are sketches of images illustrating an embodiment of a main camera including a camera display about to show a composite, such as a composite video;

FIG. 11 is a sketch of an image illustrating an embodiment of a portable (e.g., hand-held) computing device including a capability to generate video images;

FIG. 12A is a sketch showing an exploded view of an embodiment comprising an assembly embodiment that includes a radar gun embodiment, an embodiment of a portable (e.g., hand-held) computing device including a capability to generate video images, a sleeve embodiment, a clamp embodiment, and a radar gun handle/battery embodiment;

FIG. 12B is a sketch of an image showing a front perspective view of an assembly embodiment;

FIG. 12C is a sketch of an image showing a side perspective view of an assembly embodiment;

FIG. 13 is a sketch illustrating a clamp embodiment;

FIGS. 14A and 14B are sketches of images illustrating an embodiment of a portable (e.g., hand-held) computing device including a capability to generate video images, coupled via a clamp embodiment to a radar gun embodiment via a sleeve embodiment; and

FIG. 15 is a sketch of an embodiment of an application program generated display to be presented on a display screen of the portable computing device of FIGS. 14A and 14B.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As suggested previously, activities, such as by an athlete (e.g., a baseball player) may be captured (e.g., recorded)—such as via a video, for a variety of reasons including, for example, to assess performance, such as athletic performance. A baseball pitcher, for example, may be videotaped by a variety of individuals, including, for example, a coach, a scout, friends and/or family members, etc., while pitching during a baseball game, during a practice, etc., to name just a few examples. For example, a video may be a convenient approach to aid in assessing a pitcher's throwing motion. Likewise, as part of a performance assessment, various performance-related parameters (e.g., so called “telemetry” parameters) may also be independently measured. “Parameters”, “telemetry”, “performance-related parameters”, “telemetry parameters”, or the like, as used herein, refer to measurements collected to aid in assessing performance, such as athletic performance. For example, telemetry may be collected at remote locations and wirelessly communicated, such as for monitoring and/or to aid in such an assessment. For example, a radar gun may be utilized to measure velocity of a pitched baseball. Other types of telemetry may, likewise, be measured, in addition or alternatively, such as time interval between pitches, speed of a pitchers' windup, spin rate of a pitch, etc., to name just a few examples. Similarly, performance-related parameters for baseball players other than a pitcher may be measured. For example, a length of time and/or a speed at which a baserunner runs between one or more bases, such as after hitting a baseball, while stealing a base, etc., may be measured. Likewise, a baseball hitter's bat speed and/or velocity of a baseball after being hit may be measured, as further examples. Any and all of the foregoing, separately or in combinations, may be measured. Likewise, other types of performance-related parameters for other activities, including other types of sports, may be measured. It is intended that claim scope not be limited with respect to potential types telemetry that may be measured (e.g., collected).

In accordance with an embodiment, one or more images, such as a sequence thereof, which may comprise video, for example, may be captured by a main camera and may be combined with one or more images, such as a sequence thereof, which may comprise video, for example, from a secondary camera, such as a sub-camera, to generate a composite, such as one or more composite images, including as a sequence thereof, which may comprise a composite video, for example. As used herein “camera,” which may include a main camera and/or a sub-camera, refers to a camera capable of capturing one or more images, such as a sequence of images, which may comprise video. In one embodiment, a main camera may be utilized to capture video of a scene of an athlete engaged in a performance, such as an athlete throwing a baseball and/or some other activity. Likewise, a sub-camera may be used to capture video of one or more parameters, such as parameters that may relate to a video of a scene that is concurrently being captured by a main camera, for example. As an illustrative, non-limiting, example, a sub-camera may capture video of an output display of a radar gun indicating velocity of a thrown baseball. In an embodiment, a sub-camera may record video of an output display showing measurements of one or more parameters, such as a time interval between pitches, a speed of a pitchers' windup, a spin rate of a pitch, a length of time and/or a speed at which a baserunner runs between one or more bases, a baseball hitter's bat speed, a velocity at which a baseball is hit, an elevation change, a pitch type, a measured temperature and/or measured humidity level, wind speed, direction of travel of an object, stopwatch timing values, altitude, GPS values, time of day, etc., to name just a few among many examples. Thus, as shall be described in more detail later, in alternative embodiments, an output display of another device capable of generating telemetry parameter measurements other than a radar gun may be captured via imaging, such as video.

In an embodiment, video from a main camera may be combined with video from one or more sub-cameras to generate a composite video. “Composite,” as used herein, refers to a combination from two or more sources, such as a composite image, a composite video, etc. For example, a main camera may include a “picture-in-picture” feature and captured video thereof may be combined with captured video generated by a sub-camera. A “picture-in-picture” (also referred to as “picture-within-picture”) feature refers to a capability to overlay a portion of an image with (e.g., within) another image.

Accordingly, if a main camera has a picture-in-picture capability, video from a sub-camera may be combined with video from the main camera to generate a composite video, in an embodiment. For example, a main camera may be utilized to capture video of a scene of a baseball pitcher throwing a baseball and a sub-camera may capture video of an output display showing measurements of one or more parameters relating to the scene, such as an output display of a radar gun showing velocity of a thrown baseball. Thus, in an embodiment, a video of an output display, for example, may overlay a video of a scene in which a baseball is being pitched, so that velocity measurements, taken currently with capturing the scene, may appear in a video of the scene in which the baseball is thrown. That is, in this example, a main camera may generate a composite video showing the scene and the concurrently taken measurements. Furthermore, in an embodiment, wireless digital signals comprising content, such as captured video, for example, may be communicated between cameras so that a main camera is able to generate a composite, as just discussed.

In accordance with an embodiment, various relatively inexpensive off-the shelf technologies may be combined in a way to generate a composite. For example, a camera may comprise a consumer camcorder which features wireless multi-camera technology. A main camera may be wirelessly paired, such as via Wi-Fi signaling, to a second camera, such as a second camcorder. A second camera may be mounted to a device able to generate and display measurements, including, as examples, a radar gun, a smartphone, and/or a tablet, as shall be discussed herein. As an example, in accordance with an embodiment, a user may capture video of a subject and overlay currently taken measurements, including, but not limited to, temperature, altitude, GPS values, time of day, wind velocity, speed of an object, direction of travel of an object, stopwatch timing, radar signal values, etc., to name just a few examples.

Thus, as shall be described, in an embodiment, utilizing a pair of cameras that include a picture-in-picture sub-camera communication capability and a camera mounting system comprising a set of magnetic mounts, a user may capture content comprising telemetry measurements, such as generated by a smart phone, tablet screen, and/or any other device with a display screen, and may wirelessly communicate captured content providing such measurements so that a main camera is able to embed the captured content into a composite to be generated by the main camera, such as a composite video.

In an illustrative example, a baseball pitcher may be on a mound during a game. A pitcher may be a camera subject and associated telemetry measurements may be concurrently generated comprising velocity of a pitched baseball, ball spin rate, elevation change, pitch type, etc., to name just a few examples. However, without the benefit of claimed subject matter, baseball industry scouts, coaches, etc. may capture video but without including telemetry measurements. Rather, telemetry measurements, such as ball velocity, spin rate, exit velocity, home plate to first base run times, etc., may be displayed separately, such as on a hand-held radar gun, a stopwatch and/or display screens of other portable devices. As mentioned previously and discussed in more detail below, however, an embodiment of claimed subject matter may embed concurrently captured telemetry measurements into a composite, such as a camera generated composite video, for example.

In accordance with an embodiment, one or more images, such as a sequence thereof, which may comprise video images, for example, may be captured and may be combined with one or more textual and/or graphic images, such as a sequence thereof, which may comprise, for example, measurements, which, may, for example, be received from a radar gun. For example, in an embodiment, an application program may be executed or otherwise implemented, such as by a portable computing device, which may, in one example, be incorporated into a cellphone or similar hand-held device. Thus, in this illustrative example, such a device may be employed to generate a composite, such as one or more composite images, including as a sequence thereof, which may comprise a composite video, for example.

In the context of the present patent application, the term “portable computing device” and/or the like is intended to encompass a variety of potential devices that includes at least a processor and a memory able to communicate via a bus, and which also includes video imaging capability, such as by an integrated camera. Typically, but not necessarily, such devices are embodied within a cell phone, sometimes also referred to as a smartphone without any loss in generality. Thus, for convenience, it is noted here that, for purposes of the present patent application, such devices are characterized in that they at least (1) include a capability to execute an application program, (2) include a capability to capture video images; (3) are of a size such that they are capable of being handheld; and (4) they are able to process externally derived signals communicated to the device. However, a portable computing device, in this context, may include additional features such as an operating system, a web browsing capability, etc. Likewise, a portable computing device, in this context, may include a variety of additional sensors beyond a camera able to capture video images, such as simply one example, an accelerometer. Likewise, in the context of the present patent application, the term application program, application, application software, and/or the like, as used herein, is intended to refer executable software to perform a specific operation, such as for an end user or, in some cases, for another application program. Thus, an application program may be self-contained or may comprise a group of application programs.

A portable computing device, again, for example, such as embodied in a cell phone, for example, may be capable of capturing one or more images, such as a sequence of images, which may comprise video images. In one embodiment, a portable computing device may be utilized to capture video of a scene of an athlete engaged in a performance, such as an athlete throwing a baseball and/or some other activity. As an illustrative, non-limiting, example, a portable computing device may be in communication with another device external to the portable computing device, such as via a wireless connection, which may include WiFi and/or Bluetooth and/or a wired connection, for example, for measurements and/or other signals generated, for example, by a radar gun, which may correspond to the captured video. For example, measurements, such as velocity of a thrown baseball, a baseball hitter's bat speed and/or a velocity at which a baseball is hit, to name just a few examples among many, may be communicated. The term “WiFi” refers to technology for radio wireless local area networking of devices based on IEEE 802.11 standards, available from IEEE. Different versions of Wi-Fi exist, with different ranges, radio bands and speeds. Here, the term “WiFi” is used to refer to any version past, present or to be developed in the future. Likewise, the term “Bluetooth” refers to wireless technology for exchanging signals over short distances (using short-wavelength UHF radio waves in the ISM band from 2.400 to 2.485 GHz from fixed and mobile devices, and building personal area networks (PANs). Bluetooth as a standard or specification is managed by the Bluetooth Special Interest Group (SIG), which has more than 30,000 member companies in the areas of telecommunication, computing, networking, and consumer electronics. Here, again the term “Bluetooth” is used to refer to any version past, present, or to be developed in the future.

Furthermore, an application program executable on a portable computing device, such as described above, may itself determine or otherwise generate measurements and/or other signals relating to one or more parameters, such as a time spin rate of a pitch, a length of time and/or a speed at which a baserunner runs between one or more bases, an elevation change, a pitch type, a measured temperature and/or measured humidity level, wind speed, direction of travel of an object, stopwatch timing values, altitude, GPS values, time of day, etc., to name just a few examples. Of course, in such an embodiment, the particular portable computing device, in addition to the appropriate application program, would include the appropriate sensor capability. Thus, as shall be described in more detail later, in alternative embodiments, a portable computing device may be capable of generating telemetry parameter measurements other than measurements generated by an external radar gun. For example, the two devices may generate complementary measurements for use in connection with captured video, as previously described, to which such measurements may relate.

In an embodiment, captured video imaging, as previously described, may be combined with telemetry measurements that may be communicated to a portable computing device from one or more external sources and/or generated by a portable computing device to produce a composite video. “Composite,” as used herein, refers to a combination of signals and/or states from two or more sources, such as digital signals and/or states, which typically may be converted to another form, such as a content form able to be consumed by a human observer, such as audio, which may be heard, textual and/or graphic visual images, which may be seen, video images, which may be seen, etc. Thus, a composite video may include audible audio, video images and/or other visual images (e.g., textual and/or graphic visual images) combined to form the composite video. For example, via application programing, as an example, a portable computing device may include a “graphic overlay” feature so that captured video may be combined with measurements related to the captured video, but generated by an external device, such as a radar gun, as an example. Thus, here, the “graphic overlay” feature refers to a capability to overlay textual and/or graphic visual images over another image, such as a video image.

Accordingly, in an embodiment in which a portable computing device includes a graphics overlay capability measurements, for example, from an external device, such as a radar gun, may be combined with captured video to generate composite video. For example, video imaging of a scene of a baseball pitcher throwing a baseball may be captured and a radar gun may generate velocity measurement of the baseball thrown by the pitcher. The portable computing device and the radar gun may communicate such that measurements and/or other signals, may be shared between the devices, such wirelessly, for example, via WiFi, Bluetooth and/or via a wired connection. Thus, in an embodiment, for example, a portable computing device may capture video of a scene in which a baseball is being pitched, so that velocity measurements, taken concurrently with capturing the scene, may appear in a composite video of the scene in which the baseball is thrown. That is, in this example, a portable computing device may generate a composite video showing the scene and the concurrently taken measurements.

Thus, as shall be described in more detail later, in an embodiment, utilizing a portable computing device, which, for example, may be embodied in a cell phone, a customized application program and a mounting system comprising a set of magnetic mounts, for example, a user, with such a system, may produce a composite video from captured video content by embedding telemetry measurements, such as generated by an external device that is also capable of communicating the measurements, such as a radar gun, for example.

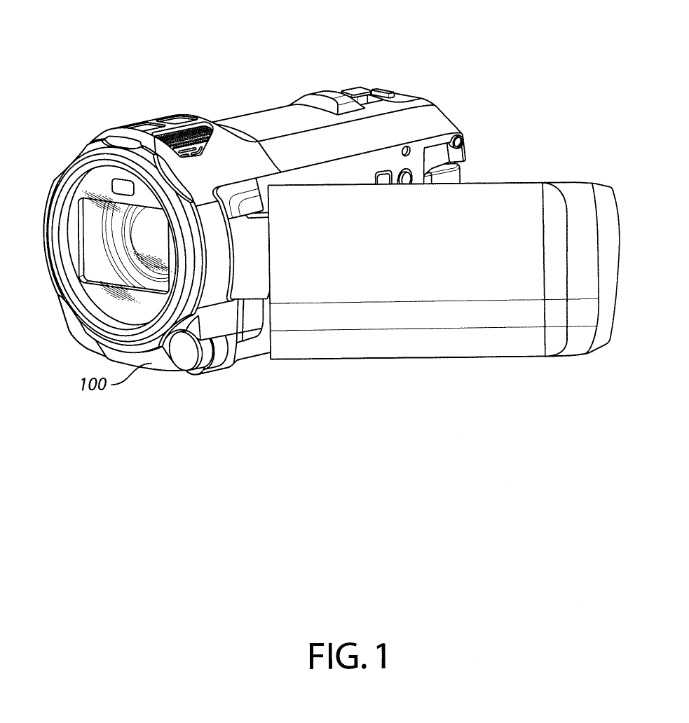

FIG. 1 is a sketch of an image illustrating an embodiment 100 of a main camera. Main camera embodiment 100 may, as an example, comprise a portable camcorder, such as, for example, a Panasonic™ HC-V770 video camera. Of course, claimed subject matter is not intended to be limited to embodiments provided for illustrative purposes, such as the foregoing. Main camera embodiment 100 may, for example, be held in a user's hand to capture video of a scene, such as, again, as illustrative, but non-limiting examples, a baseball player throwing a pitch, batting, etc. In some implementations, main camera embodiment 100 may instead be mounted on a tripod or in some other manner to capture video even if a user is not physically holding it, for example. In an embodiment, as previously suggested, main camera embodiment 100 may include a wireless capability, such as via use of communication circuitry, to transmit and/or receive wireless signals comprising content, such as video of a scene. Nonetheless, in one or more implementations, main camera embodiment 100 may likewise include one or more plugs, ports, receivers, wires, and/or other components to physically connect to another device, such as a computer and/or another video camera, via a wired connection, for example.

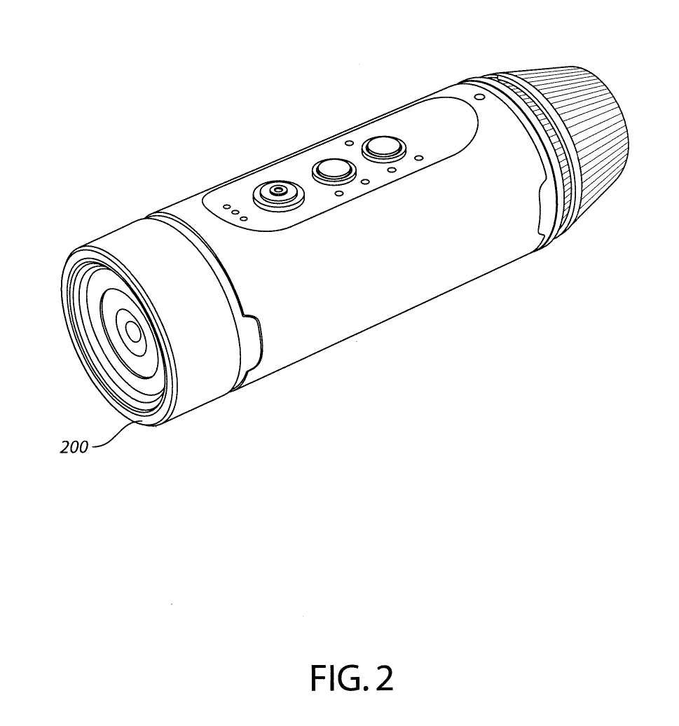

FIG. 2 is a sketch of an image illustrating an embodiment 200 of a sub-camera. Sub-camera embodiment 200 may comprise, for example, a Panasonic™ HX-A1M video camera, for example; although, again, claimed subject matter is not limited in this respect. Sub-camera embodiment 200 may, for example, comprise a camera capable of communication, such as via Wi-Fi. For example, main camera embodiment 100 and sub-camera embodiment 200 may be capable of communicating digital signals comprising content, such as, for example, captured video. Likewise, in an embodiment, main camera and sub-camera embodiments 100 and 200 may respectively be capable of operating in accordance with communicated control signals, such as communicated signals for remote control operation. Thus, as an example, via remote signaling, main camera embodiment 100 and sub-camera embodiment 200 may concurrently capture video which may, also via remote signals and via device (e.g., camera) communications, result in main camera embodiment 100 generating a composite video that includes video captured by sub-camera embodiment 200. Likewise, in another embodiment, a user may utilize an application program on his or her smartphone, computing device, etc., so that a sub-camera is able to capture content (e.g., audio, images, and/or video) from another device other than a radar gun and/or communicate digital signals comprising captured content. Furthermore, other devices may include similar capabilities as described between cameras. For example, a smart phone may be able to capture content, such as video content, for example, and a communication capability, for example, between a smart phone and a camera may permit generation of a composite video, such as via the camera, for example.

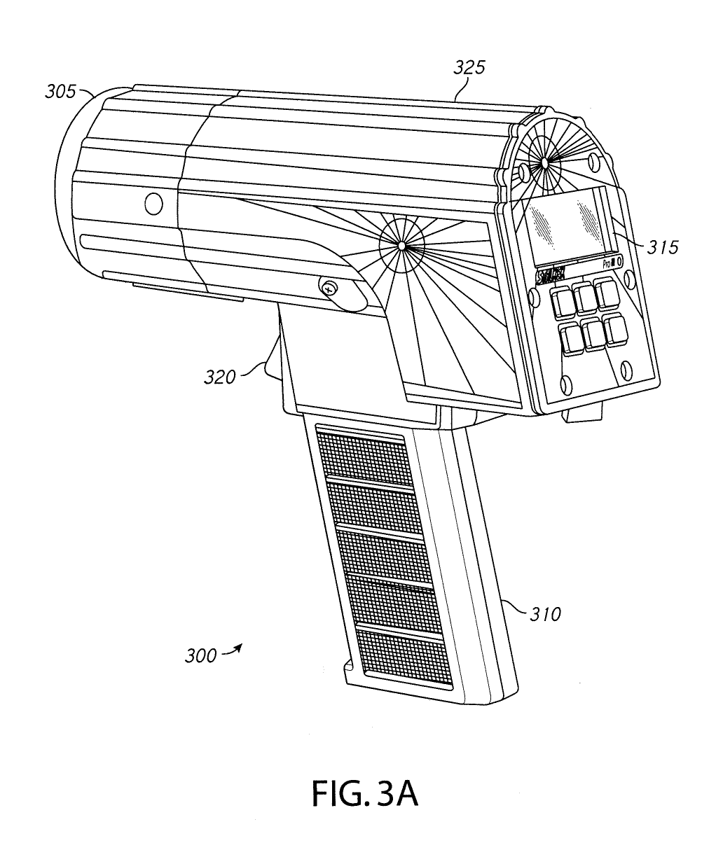

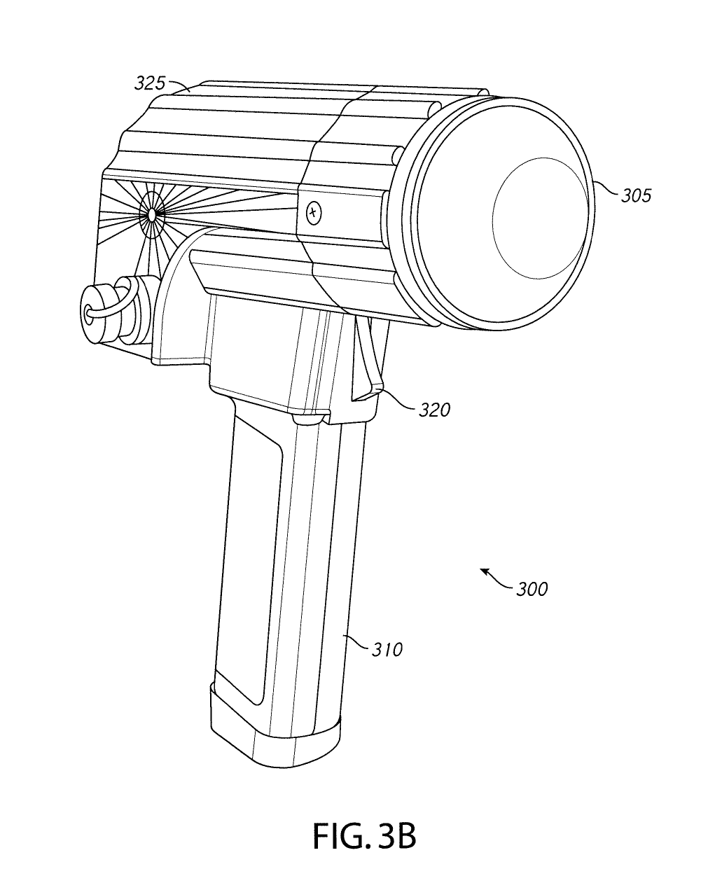

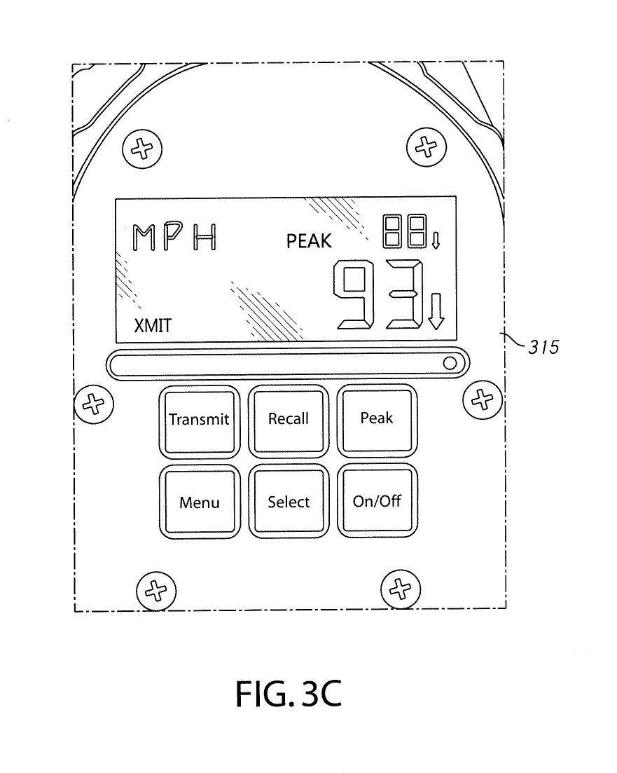

FIGS. 3A and 3B are sketches of images illustrating alternate views of an embodiment 300 of a radar gun. Thus, radar gun embodiment 300 may be utilized to measure velocity, such as velocity of a pitched baseball, an exit velocity of a baseball hit by a batter, a batter's bat speed, etc., to name just a few examples. Radar gun embodiment 300 may generate one or more electromagnetic pulses and process pulse reflections from an object to which embodiment 300 had been pointing. Likewise, processing of electromagnetic pulse reflections by radar gun embodiment 300 may result in measurements of desired parameters, such as those mentioned previously, as examples. Similarly, however, other measurement devices, as alluded to, and described in more detail later, may provide measurements of desired parameters.

Radar gun embodiment 300 may include a handle 310, as shown in FIG. 3, which a user may grip to hold radar gun embodiment 300. In one particular implementation, handle 310 may include a battery, such as a lithium-ion battery and/or other circuitry, for example, to deliver power for radar gun operation. Radar gun embodiment 300 may also include a trigger 320 to generate one or more electromagnetic pulses, for example, to be directed at an object in motion, such as a baseball. Radar gun embodiment 300 may also include an output display 315 to show various measurements, such as a velocity at which a baseball was thrown, for example. As an illustration, radar gun embodiment 300 may comprise a “Stalker Pro II” or “Stalker Pro II+” radar gun manufactured by Stalker Radar, Inc. As shown in FIG. 3, such as 3A and/or 3B, radar gun embodiment 300 may also include several ridges 325 that are raised above a relatively smooth radar gun surface and that extend along a radar gun shaft.

FIG. 3C is a sketch of an image that illustrates an output display 315 of embodiment 300. Output display 315 may comprise a liquid crystal display (LCD) or other type of display capable of at least visually displaying parameter values of measurements generated by radar gun embodiment 300. For example, output display 315 may indicate a measured velocity, such as in miles/hour, kilometers/hour, etc. of an object in motion, for example.

Without the benefit of claimed subject matter, a variety of less desirable approaches may be employed to obtain measurements for use, for example, in assessing athletic performance. In one approach, a baseball coach, scout, etc., for example, may hold a camera to capture video of a scene, such as of a pitcher throwing a baseball, and a different person may hold a radar gun to measure velocity at which the baseball is thrown. Alternatively, a camera may be mounted onto a tripod to capture video as a radar gun is pointed to take measurements. Thus, more than one person would not be needed in this latter example. Nonetheless, it may be more beneficial, or at least more convenient, to have concurrently obtained measurements available in a manner that clarifies correspondence with those actions from which the measurements were obtained. In one approach, a person holding a radar gun may speak into a microphone coupled to or otherwise in communication with a camera so that, for example, the person may recite a measured velocity indicated on an output display of the radar gun in order to add radar gun measurements to the video. However, this approach has some disadvantages. For example, substantial background noise or a faulty microphone may interfere with such an approach. Moreover, it is relatively cumbersome and may be subject to potential for human error. Similarly, in another approach, a user may manually type a measured velocity via use of a device, such as a keyboard or keypad, in a manner so that generated text may also be displayed by the device and captured on video taken by the camera as the camera captures the actions of a scene. That is, the display of such a device may be within the field of view of the camera as it captures the scene. However, again, this may be cumbersome and potentially prone to instances of user error.

For example, in accordance with an embodiment as discussed herein, videos may be combined into a composite video for improved convenience. As an example, a main camera may be utilized to capture video of a scene of a baseball player throwing a baseball. Likewise, various output displays may visually provide measurements for various parameters that correspond to a scene captured by a main camera, such as if measurements are taken concurrently with capturing a video. For example, an output display of a radar gun may indicate velocity of a thrown baseball, a player's bat speed, an exit velocity of a hit baseball, etc., as previously mentioned. As other examples, an output display of a smart phone may, for example, show measurements of temperature, wind speed, humidity, elevation, etc., for example, as measured by smart phone sensors in which a related smartphone application may process and display sensor measurements. Similarly, an output display of a smart phone may show a clock to indicate a time of day, a stopwatch to show timing values, etc., to indicate time between pitches, time for a player to steal a base, time to run between bases, etc. Of course, a host of telemetry is capable of being measured and capable of being visually displayed. Thus while a few examples have been mentioned, nonetheless, for sake of brevity, it is to be understand that claimed subject matter is intended to include any and all telemetry measurements.

In an embodiment, a main camera and a sub-camera may communicate, via one or more digital signals, video that has been captured, such as via wireless communications (e.g., Wi-Fi). Thus, as an example, a sub-camera video may be embedded into video captured by a main camera. For example, if a main camera has a picture-within-picture capability, video captured by a sub-camera may be embedded via a picture-within-picture capability within video of a scene captured by the main camera to generate a composite video. In an embodiment, a user may capture video of a scene of a baseball player throwing a baseball and a sub-camera may concurrently capture video of an output display of a radar gun measuring speed of a baseball thrown, as an example.

In accordance with an embodiment, one detachable camera mount may physically couple a main camera to a radar gun so that the main camera may capture video of a scene while the radar gun may be utilized to measure velocity of a thrown baseball, a bat speed, an exit velocity of a hit baseball, etc., as example. Likewise, another camera mount may detachably attach a sub-camera to the radar gun to capture video of a display screen of the radar gun. In another example, however, a sub-camera may be positioned within a mount to record video of an output display of a smart phone, a timer, and/or some other device capable of visually displaying one or more telemetry measurements. Thus, a system of camera mounts, in one embodiment, for example, as discussed herein, may permit a user to capture video obtained by a sub-camera to embed the video into a composite video of a scene captured by a main camera, such as via a picture-in-picture feature of the main camera.

Camera mounts, as discussed herein, may provide various advantages including reduced cost (e.g., in comparison with a custom designed and custom built device) and/or ease of use. For example, one person may readily hold a radar gun to which a camera mount is attached to record video of a baseball player throwing a pitch via a main camera, measure a speed of the pitch via the radar gun, and embed video of an output display of the radar gun indicating velocity of the pitch, for example, into a single composite video. Moreover, using a main camera with picture-in-picture capabilities and via camera-to-camera wireless communications between a main camera and a sub-camera, neither camera need be redesigned or re-coded to function as discussed herein.

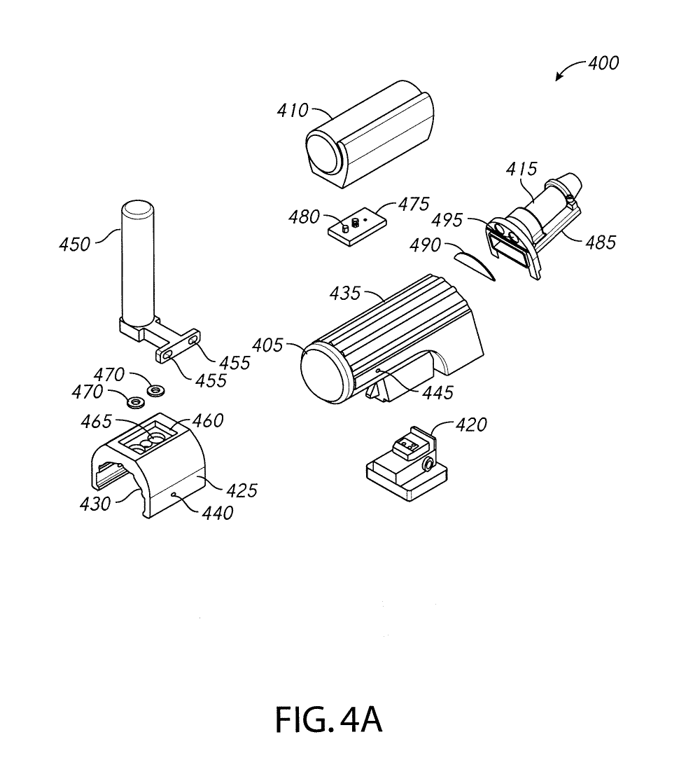

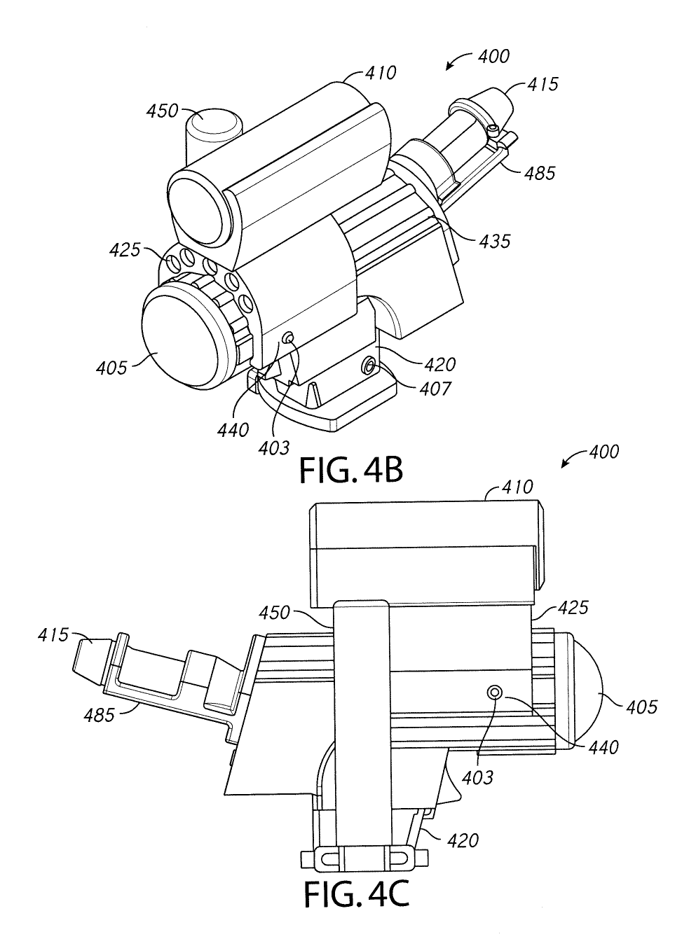

FIG. 4A is a sketch showing an exploded view of an embodiment 400 comprising an assembly embodiment that includes a radar gun embodiment 405, a main camera embodiment 410, and a sub-camera embodiment 415. Radar gun embodiment 405 may be coupled to an electronic connector component embodiment 420. Electronic connector component embodiment 420 may include a circuit board in one particular example to permit power to be delivered, such as to 405, in order for operation to take place. In an embodiment, electronic connector component embodiment 420 may also be coupled to a tripod or another component to support radar gun embodiment 405 in place as radar gun embodiment 405 receives electrical power from electronic connector component embodiment 420. For example, electronic connector component embodiment 420 may comprise a battery, may be electrically connected to a battery, and/or may be electrically connected to another power source, such as a power outlet. As shown in FIG. 4A, electronic connector component embodiment 420 may include a male connector port to connect with a female connector port on an underside of a base of radar gun embodiment 405 such as, for example, to establish electrical connection between electronic connector component embodiment 420 and radar gun embodiment 405 and to detachably secure the base of radar gun embodiment 405 to electronic connector component embodiment 420.

One example embodiment of a camera mount may include a sleeve embodiment 425 that may slide onto a cylindrical portion of a body of radar gun embodiment 405. Sleeve embodiment 425 may be formed of a nylon material in one particular implementation; although claimed subject matter is not limited in this respect. Other materials may be employed and provide satisfactory performance. As one example, plastic may be employed. Sleeve embodiment 425 may include a plurality of grooves 430 on an underside which may extend along a length of a body of sleeve embodiment 425. In an embodiment, sleeve embodiment 425 may slide onto a cylindrical portion of a body of radar gun embodiment 405 and grooves 430 may mate with ridges 435 that are raised above a relatively smooth surface of radar gun embodiment 405 so as, for example, to hinder rotational movement between sleeve embodiment 425 and radar gun embodiment 405.

Sleeve embodiment 425 may include a non-threaded hole 440 and radar gun embodiment 405 may include a non-threaded hole 445. If sleeve embodiment 425 is positioned so that threaded hole 440 and threaded hole 445 are aligned, a screw, for example, may pass the respective holes and be threaded via 445 to thereby secure sleeve embodiment 425 to radar gun embodiment 405 and to further hinder relative movement.

A top portion of sleeve embodiment 425 may include an inset portion 460. Inset portion 460 may include one or more recesses 465. An embodiment, as shown in FIG. 4A, includes two recesses 465, although in other implementations one or more than two recesses 465 may be utilized and may provide at least satisfactory results. One or more washers 470 may be affixed to one or more recesses 465. In an embodiment, as shown in FIG. 4A, respective washers 470 may be affixed to respective recesses 465, although more than one washer 470 may be affixed to one or more recess 465 in other implementations. A washer 470 may be affixed to a recess 465 by an adhesive, such as an epoxy and/or glue, for example. A washer 470 may comprise a ferromagnetic material, such as nickel, which is capable of being attracted to a magnet. However, in another embodiment rectangularly shaped metallic material forming a plate may be used rather than washers. For example, steel may be employed rather than nickel. Thus, claimed subject matter is not restricted as to a particular material subject to magnetic attraction and claimed subject matter is not restricted as to shape. Likewise, in an embodiment, recesses 465 may be formed in a manner to assist in maintaining a component in place, such as a rectangularly shaped metallic component, (e.g., plate) for example.

Continuing with FIG. 4A, in an embodiment, a plate embodiment 475 may be affixed to a side of main camera embodiment 410, such as to a bottom side. For example, a bottom side of main camera embodiment 410 may include one or more threaded holes to receive one or more screws. Plate embodiment 475 may include one or more magnets located on a side opposite (e.g., obverse) to a side via which plate embodiment 475 is affixed to main camera embodiment 410. If, for example, a topside of plate embodiment 475 is affixed to a bottom side of main camera embodiment 410, such as via one or more screws, a bottom side of plate embodiment 475, also referred to above as an obverse side, may include one or more magnets. For example, one or more magnets may adhere to a bottom side of plate embodiment 475, such as via an adhesive, such as epoxy and/or glue, as examples, and/or may be attached in some further manner, such as via a screw. If plate embodiment 475 is affixed to a bottom side of main camera embodiment 410, plate embodiment 475 may be placed within insert 460 of sleeve embodiment 425, such as to detachably attach main camera embodiment 410 to sleeve embodiment 425 via magnetic attraction between one or more magnets of plate embodiment 475 and washers 470. In an embodiment, magnets of plate embodiment 475 may have respective shapes similar to washers 470 so as to rest flush against the washers for a relatively strong magnetic attraction thereto, for example. In one particular implementation, as an illustration, one or more magnets may be utilized within plate embodiment 475 which may be rated with 12 lbs of holding capacity, although magnets of different holding capacity may likewise be utilized and provide adequate attraction. FIG. 9, as discussed in more detail below, is a diagram that shows an embodiment of a plate, such as 475.

A handle 450 (e.g., hand grip) may be coupled to embodiment 400 via one or more screws. Handle 450 may be coupled to electronic connector component embodiment 420 or to a bottom portion of radar gun embodiment 405 via insertion of screws into threaded holes 455, for example. In an embodiment, a battery, such as a lithium ion battery, and/or other electronic circuitry, may be included within an interior of handle 450. By including a battery within an interior of 450, for example, embodiment 400 may be kept more compact in size.

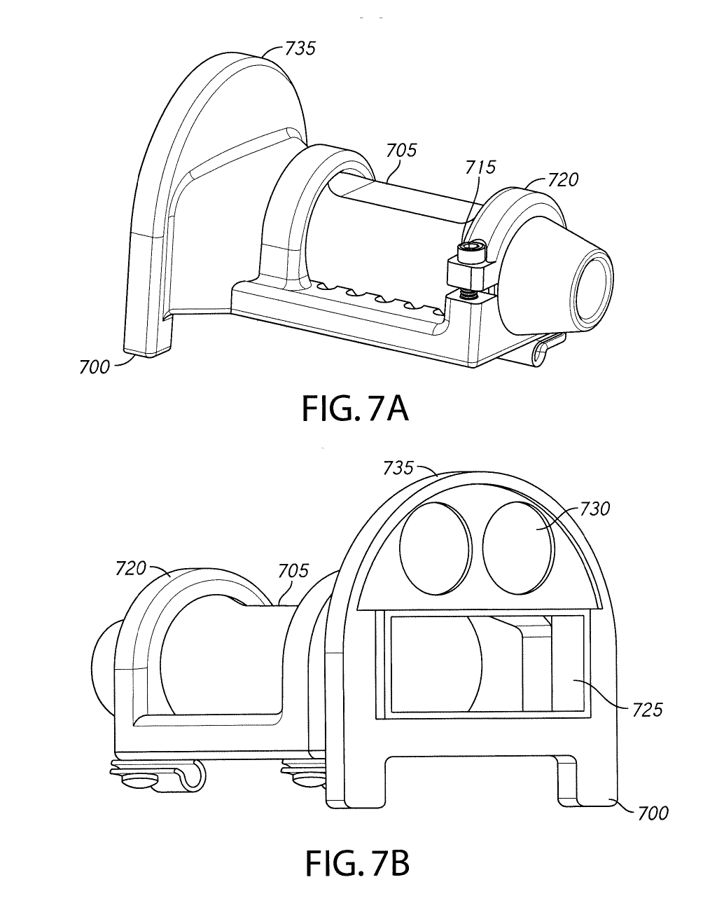

A sub-camera mount embodiment 485 may be utilized to mount sub-camera embodiment 415 to embodiment 400. In one particular implementation, sub-camera mount embodiment 485 may support sub-camera embodiment 415 in a particular position such that sub-camera embodiment 415 is capable of capturing video of an output display on radar gun embodiment 405, as discussed previously, as well as discussed further below with respect to FIGS. 7A-B.

A thin metal plate 490, shaped like a portion of a circle (e.g., half-moon or similar shape) may be affixed to a portion of radar gun embodiment 405 above an output display of the radar gun. For example, thin metal plate 490 may be affixed to radar gun embodiment 405 via adhesive, such as an epoxy and/or glue and/or may otherwise be coupled to radar gun embodiment 405, such as via a screw in one particular implementation. As shown, for example, by a sketch of an image in FIG. 6, thin metal plate 490, corresponding to 605 in FIG. 6, may be formed as a shape similar to that of a portion of radar gun embodiment 405 immediately above an output display (e.g., between a top surface of the radar gun and a top of the output display). In an example shown in FIG. 4A, 490 has a shape similar to a circular portion (e.g., semicircle or half-moon), as previously mentioned.

With 490 adhering to radar gun embodiment 405, sub-camera mount embodiment 485 may be detachably attached to embodiment 400 via magnetic attraction. For example, one or more magnets may be included within a portion of sub-camera mount embodiment 485 facing radar gun embodiment 405. As shown in FIG. 4A, two magnets 495 may adhere to a back side of mount 485, roughly above a location at which sub-camera embodiment 415 is intended to be positioned. Although two magnets 495 are depicted in FIG. 4A of course, more or fewer than two magnets may be utilized and still provide satisfactory results. Thus, in an embodiment, sub-camera mount embodiment 485 may be coupled to radar gun embodiment 405 via magnetic attraction between thin metal plate 490 attached to radar gun embodiment 405 and magnets 495 of sub-camera mount embodiment 485. In one particular implementation, magnets 495 may be utilized which are rated with approximately 15.2 lbs of holding capacity, although magnets of different holding capacity may be utilized and still provide satisfactory performance.

FIG. 4B is a sketch of an image showing a front perspective view of embodiment 400. FIG. 4B illustrates, for example, an assembled version of embodiment 400, which is shown as exploded in FIG. 4A. FIG. 4C is an image showing a side view of embodiment 400, again, after having been assembled. FIG. 4C illustrates, for example, one side of an assembled version of embodiment 400 (e.g., the side with handle 450). As shown in FIGS. 4B and 4C, sleeve embodiment 425 may be utilized to couple main camera embodiment 410 to radar gun embodiment 405. Sub-camera mount embodiment 485 may be utilized to detachably attach or affix sub-camera embodiment 415 to radar gun embodiment 405. As illustrated, a screw 403 may be utilized to secure sleeve embodiment 425 to radar gun embodiment 405 via threaded hole 440. Electronic connector component embodiment 420 may include a female port 407 capable of being coupled to a male connector. For example, digital signals comprising content, such as video content, for example, may be accessed via such a port.

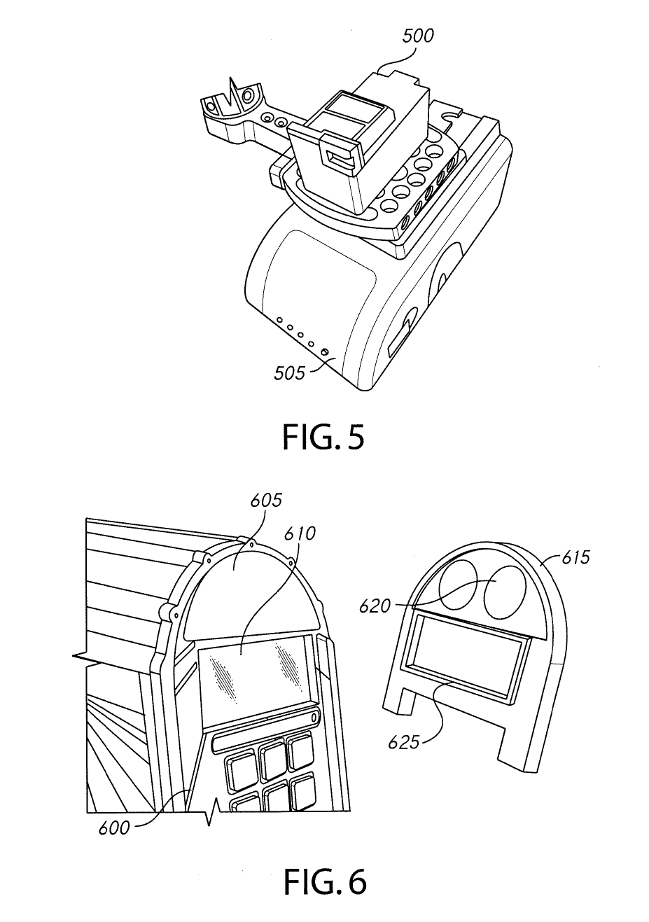

FIG. 5 is a sketch of an image illustrating an embodiment 500 of an electronic connector component. Electronic connector component embodiment 500 may be similar to, or in some cases even the same as, electronic connector component embodiment 420, shown in FIGS. 4A-C and previously discussed. As was mentioned, electronic connector component embodiment 420 may include a circuit board, such as to connect to a radar gun, for example. Electronic connector component 500 may be coupled to a battery pack 505 or other type of battery. Likewise, electronic connector component embodiment 500 may be utilized to couple battery pack 505 to a radar gun to, for example, provide electrical power to the radar gun. In one particular implementation, battery pack 505 may comprise a BubblePack™ lithium-ion battery pack; although, of course, claimed subject matter is not intended to be limited to illustrative examples, such as the foregoing.

FIG. 6 is a sketch of an image that illustrates a radar gun embodiment 600 and a sub-camera mount embodiment 615. Thus, radar gun embodiment 600 may be similar to, or even the same as, radar gun embodiment 405 shown in FIGS. 4A-C and discussed above, for example. Radar gun embodiment 600 may include an output display 610 to display measured parameters, for example, such as miles or kilometers per hour. Radar gun embodiment 600 may also include a metal plate 605. For example, metal plate 605 may be similar to, or even the same as, thin metal plate 490 shown in FIG. 4A and previously discussed. Output display 610 may have an approximately rectangular shape in one particular embodiment and may be inset by several millimeters, for example.

Sub-camera mount embodiment 615 may include a protruding portion 625. Protruding portion 625 may extend several millimeters alone a side edge of sub-camera mount 625. Sub-camera mount embodiment 615 may be positioned so that a protruding portion (e.g., raised ridge) 625 is able to be aligned to fit relatively snugly against an inset portion of output display 610 of radar gun embodiment 600. In an implementation, a sub-camera, such as sub-camera embodiment 415 shown in FIGS. 4A-C, may be positioned within sub-camera mount embodiment 615 so that the sub-camera may be capable of capturing video as may be seen via protruding portion 625.

Sub-camera mount embodiment 615 may include one or more magnets 620. In an embedment shown in FIG. 6, two magnets 620 may be utilized, although one or more than two magnets may be utilized and provide satisfactory performance. As discussed above with respect to magnets 495 shown in FIG. 4A, magnets 620 may be utilized to attach sub-camera mount embodiment 615 to radar gun embodiment 600 such that magnets 620 of sub-camera mount embodiment 615 are flush against metal plate 605 for at least adequate magnetic attraction between sub-camera mount embodiment 615 and radar gun embodiment 600.

FIGS. 7A and 7B are sketches of images illustrating perspective views of a sub-camera mount embodiment 700 for a sub-camera embodiment 705. Sub-camera mount embodiment 700 may be formed of a material, such as nylon, in a particular implementation; although, again, claimed subject matter is not limited in this respect. Other materials, such as plastic as one example, may be employed and provide satisfactory performance. Sub-camera embodiment 705 may be secured within sub-camera mount embodiment 700 by an arm 720, an end portion of which may be reasonably secured to hold a sub-camera, such as embodiment 705, in place, such as via use of a screw 715, for example, as shown in FIG. 7A.

As illustrated in FIG. 7B, a side base portion 735 of sub-camera mount embodiment 700 may include two magnets 730 to magnetically attach sub-camera mount embodiment 700 to a metal plate, such as one attached to a radar gun embodiment, as discussed above with respect to FIGS. 4A and 6, for example. As discussed previously, although two magnets are shown in FIG. 7B, one or more than two magnets may be utilized and still provide satisfactory performance. FIG. 7B illustrates a protruding portion (e.g., raised ridge) 725 to engage with an inset portion of an output display of a radar gun embodiment, as discussed above with respect to FIG. 6.

As shown in FIGS. 7A and 7B, sub-camera embodiment 705 may be positioned within sub-camera mount embodiment 700 to face a side base portion 735 so as to capture video via protruding portion 725. Of course, a sub-camera, such as embodiment 705, may be positioned in a different manner in other implementations that may include slightly different configurations with respect to an output display, for example.

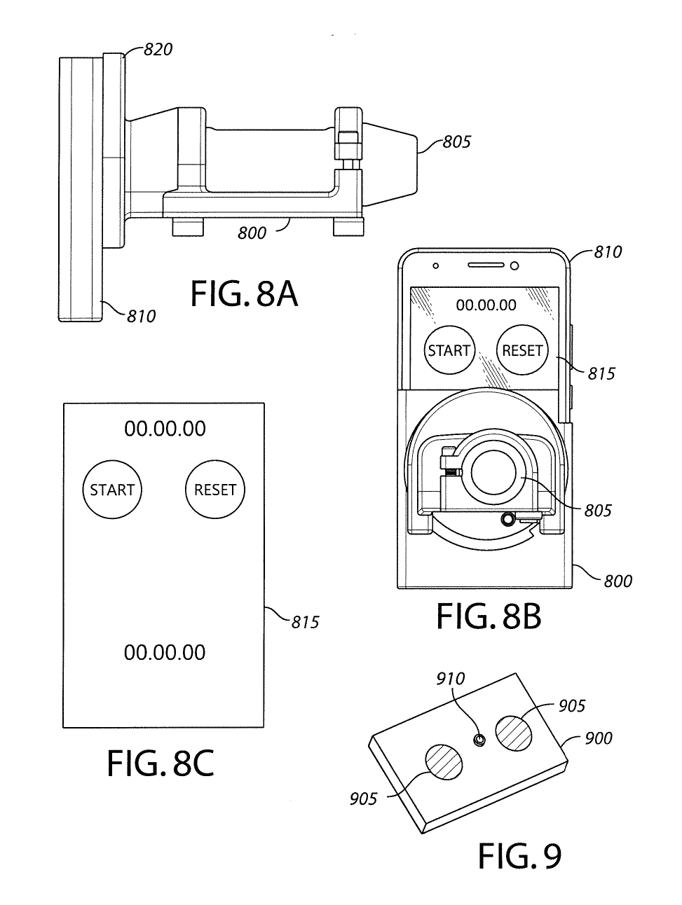

FIGS. 8A-C are sketches of images illustrating various views of another embodiment 800 of a sub-camera mount to hold a sub-camera 805 to capture video of an output display, in this illustration, in connection with a smart phone embodiment 810. FIG. 8A shows a side base portion 820 of sub-camera mount embodiment 800 positioned approximately flush against smart phone embodiment 810, such as an iPhone™ device or an Android™ smart phone, to provide a few non-limiting examples.

FIG. 8B illustrates smart phone embodiment 810 having an output display 815, such as to provide a stopwatch (e.g., timing) operation. In an example, a person may utilize smart phone embodiment 810 to measure timing between a player's pitches, to time how quickly a batter runs between bases, etc., to name just a couple of potential uses out of many possible examples. Sub-camera embodiment 805 may be utilized to, again, capture video of output display 815, which may be combined with video generated by a main camera, as discussed previously, so as to have the main camera, in an embodiment, generate a composite video. Sub-camera mount embodiment 800 may be positioned so that sub-camera embodiment 805 faces output display 815. FIG. 8C illustrates a snapshot of an output display 815, video of which may, again, be captured via sub-camera embodiment 805 positioned within sub-camera mount embodiment 800, for example. As was discussed, in an embodiment, via wireless communication signals, video captured by sub-camera embodiment 805 may be employed by a main camera to generate a composite video.

FIG. 9 is a sketch illustrating an obverse side of a plate embodiment 900 to be coupled to a bottom portion of a main camera embodiment, for example. Plate embodiment 900 may be similar to plate embodiment 475, as discussed above with respect to FIG. 4A. Plate embodiment 900 may include two magnets 905, although, again, a different number of magnets 905 may be utilized in an implementation and still provide at least adequate results. Plate embodiment 900 may be secured to a bottom portion of a main camera, such as embodiment 410, as one example, via a screw 910, which may be screwed into a threaded hole on the bottom portion of a main camera embodiment. Plate embodiment 910 may be positioned so that magnets 905 are disposed on a side obverse to a bottom portion of a main camera embodiment. Thus, with plate embodiment 910 mounted onto a bottom portion of a main camera embodiment, the plate may subsequently be placed within a sleeve, such as sleeve embodiment 425, shown in FIGS. 4A-C and previously discussed, so that magnets 905 are able to be positioned flush against metal washers of the sleeve, again, in an embodiment and as previously discussed, such that a magnetic force of attraction may detachably attach a main camera embodiment to a sleeve, such as embodiment 425, via plate embodiment 900.

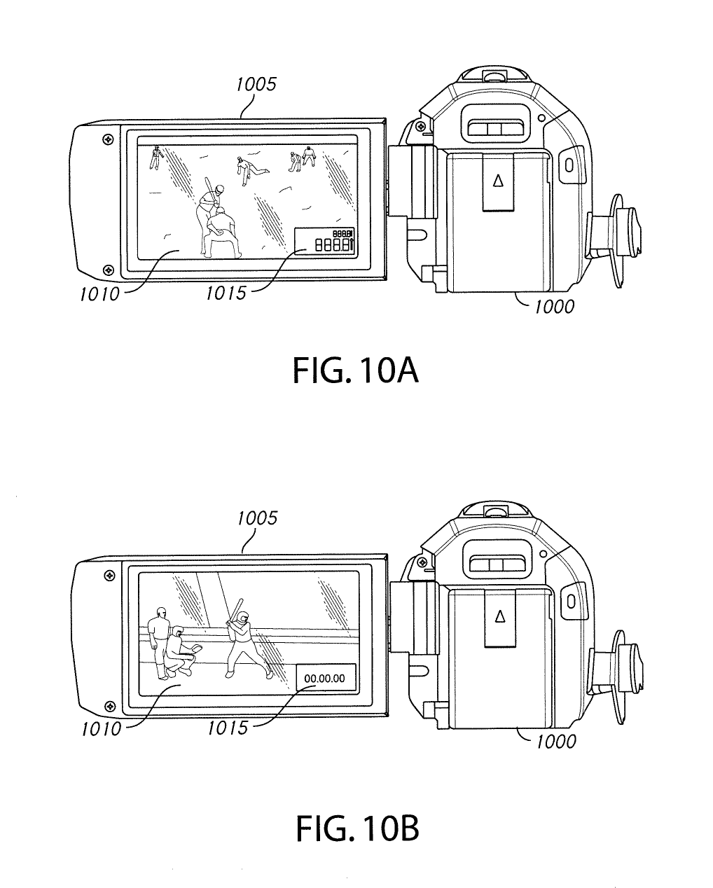

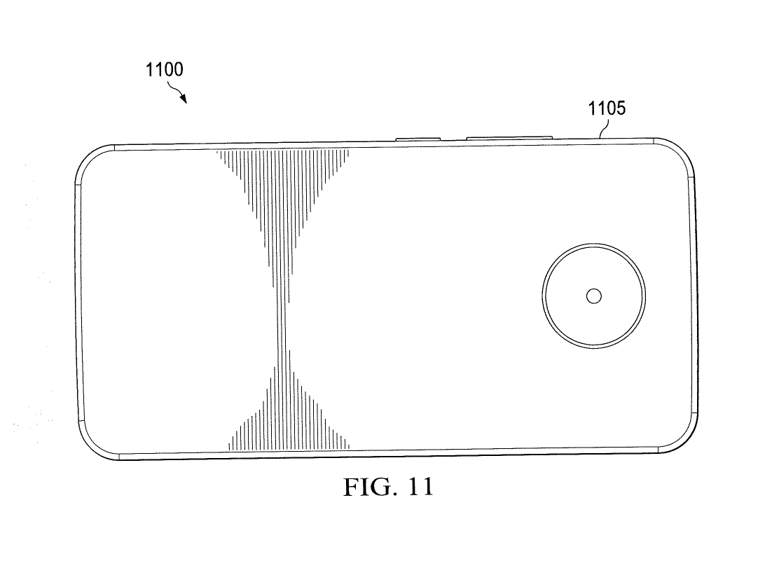

FIGS. 10A and 10B are sketches of images illustrating a main camera embodiment 1000 having an output display 1005, for example, to show a composite video. As illustrated, main camera embodiment 1000 may include a picture-in-picture feature to display a composite video comprising a first video window 1010 to display video to be captured by main camera embodiment 1000 and a second video window 1015 to display video to be captured by a sub-camera embodiment in which, for example, wireless communication signals between the camera embodiments permits generation of a composite video by main camera embodiment 1000. In FIG. 10A, a first video window 1010 may comprise a first video of a baseball pitcher throwing a baseball, and second video window 1015 may comprise a second video of an output display of a radar gun, such as embodiment 405, for example. Thus, with a sub-camera, such as embodiment 415, for example, positioned to capture video of an output display of a radar gun, such as embodiment 405, for example, pointed in a manner so as to generate velocity measurements with respect to a pitched baseball, as shown in first video window 1010, velocity measurement of the baseball may be shown on an output display of the radar gun embodiment and may be captured by the sub-camera embodiment in the second video. In an embodiment, wireless communications between camera embodiments permits the main camera to generate a composite video, such as via a picture-in-picture feature, in which velocity measurements, in this example, are included within the video of the pitching action by a pitcher, for example.

FIG. 10B shows a first video window 1010 which may comprise a first video of a baseball player, and second video window 1015 which may comprise a second video of an output display of a smart phone, such as smart phone embodiment 810, as discussed above with respect to FIGS. 8A-C in which, as an example, a stopwatch (e.g., timer) is displayed. For example, if a sub-camera embodiment, such as 805, is positioned to capture video of an output display of a smart phone, such as embodiment 810, a stopwatch measurement may be captured via a second video by a sub-camera so that wireless communications between camera embodiments permits the main camera to generate a composite video, such as via a picture-in-picture feature, so that timing measurements are included within the video of action by a baseball player, for example.

FIG. 11 is a sketch of an image illustrating an embodiment 1100 of a portable computing device, which, as previously described may be embodied in a cell phone, sometimes also referred to as a smartphone. Embodiment 1100 may, as an example, comprise a built-in camera 1105, one or more processors, and one or more memory devices, such as to store code capable of being executed by the one or more processors and/or to store output signals and/or states generated by camera 1105, for example. As previously suggested, one or more processors of embodiment 1100 may be capable of implementing, executing, or otherwise running an application program which may, along with hardware features of embodiment 1100, provide video imaging capability. One example of such a device is an Apple® model MT042LL/A iPhone XR. Of course, claimed subject matter is not intended to be limited to embodiments provided for illustrative purposes, such as the foregoing device example.

Embodiment 1100 may, for example, be held in a user's hand to capture video of a scene, such as, again, as illustrative, but non-limiting examples, a baseball player throwing a pitch, batting, etc. In some implementations, embodiment 1100 may instead be mounted on a tripod or in some other manner to capture video even if a user is not physically holding it, for example. In an embodiment, as previously suggested, embodiment 1100 may include a wireless communication capability, such as via use of communication circuitry, to transmit and/or receive wireless signals comprising content, such as video of a scene. Nonetheless, in one or more implementations, embodiment 1100 may likewise include one or more plugs, ports, receivers, wires, and/or other components to provide a capability to communicate by being in direct physical contact with another device, such as via a wired connection, for example.

For example, in accordance with an embodiment as discussed herein, video images may be combined into a composite video for improved convenience. As an example, a portable computing device, such as embodiment 1100, for example, may be utilized to capture video of a scene of a baseball player throwing a baseball. Likewise, various other external devices and/or embodiment 1100 itself, for example, may provide measurements for various parameters that correspond to a captured video scene, such as if measurements are taken concurrently with capturing a video. For example, measurements captured by a radar gun may indicate velocity of a thrown baseball, a player's bat speed, an exit velocity of a hit baseball, etc., as previously mentioned. As other examples, measurements capable of being generated by embodiment 1100, for example, may provide measurements of temperature, wind speed, humidity, elevation, etc., for example, as measured by sensors included as part of embodiment 1100, via use of an executable application program to process an/or display measurements generated by the sensors of embodiment 1100.

Similarly, an executable application program for embodiment 1100 may generate a stream of measurements, such as via a clock to indicate a time of day, via a stopwatch to show timing values, etc., for example, to indicate time between pitches, time for a player to steal a base, time to run between bases, etc. Of course, a host of telemetry is capable of being measured and capable of being visually displayed. Thus while a few examples have been mentioned, nonetheless, for sake of brevity, it is to be understood that claimed subject matter is intended to include any and all telemetry measurements capable of being generated via appropriate sensors included in a portable computing device which would be of use in connection with captured video of athletic performances, for example.

In accordance with an embodiment, a detachable mount for a portable computing device, such as embodiment 1100, may physically couple the portable computing device to a radar gun so that a camera of the portable computing device may capture video of a scene while the radar gun may be utilized to measure velocity of a thrown baseball, a bat speed, an exit velocity of a hit baseball, etc., as an example.

A mount for a portable computing device, such as embodiment 1100, for example, as discussed herein, may provide various advantages including reduced cost (e.g., in comparison with a custom designed and custom built device) and/or ease of use. For example, one person may readily hold a radar gun to which a portable computing device mount is attached to capture video of a baseball player throwing a pitch via a camera of the portable computing device, measure a speed of the pitch via the radar gun, and embed measurements from the radar gun indicating velocity of the pitch, for example, into a composite video. For example, a portable electronic device, such as embodiment 1100, may include graphic overlay capabilities, which may be used to embed measurements generated by a radar gun, for example, via communications between the radar gun and embodiment 1100, for example.

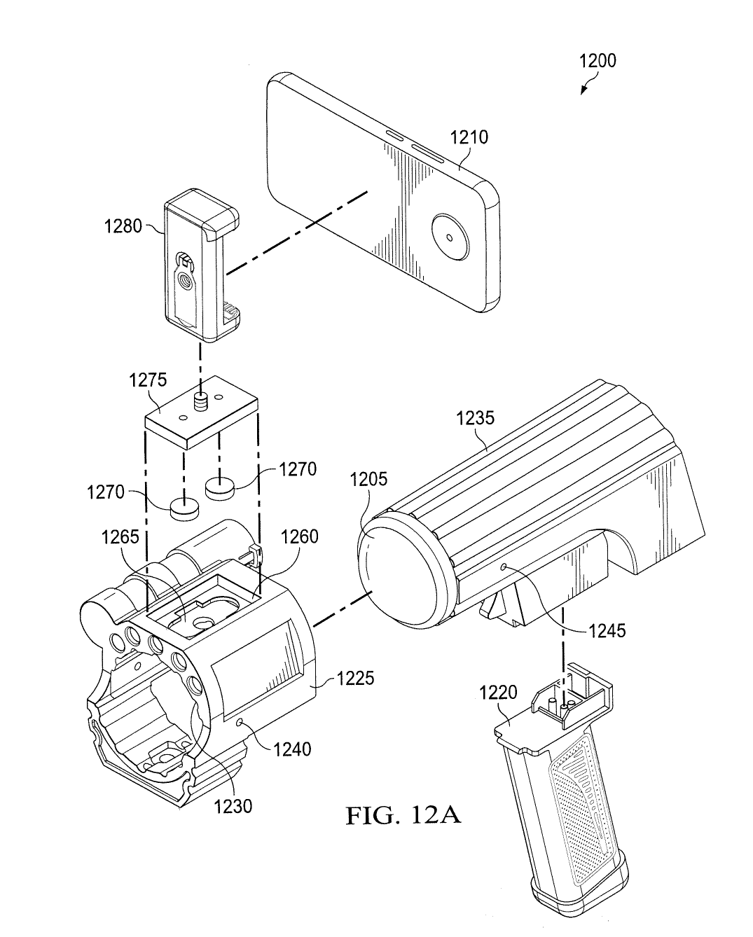

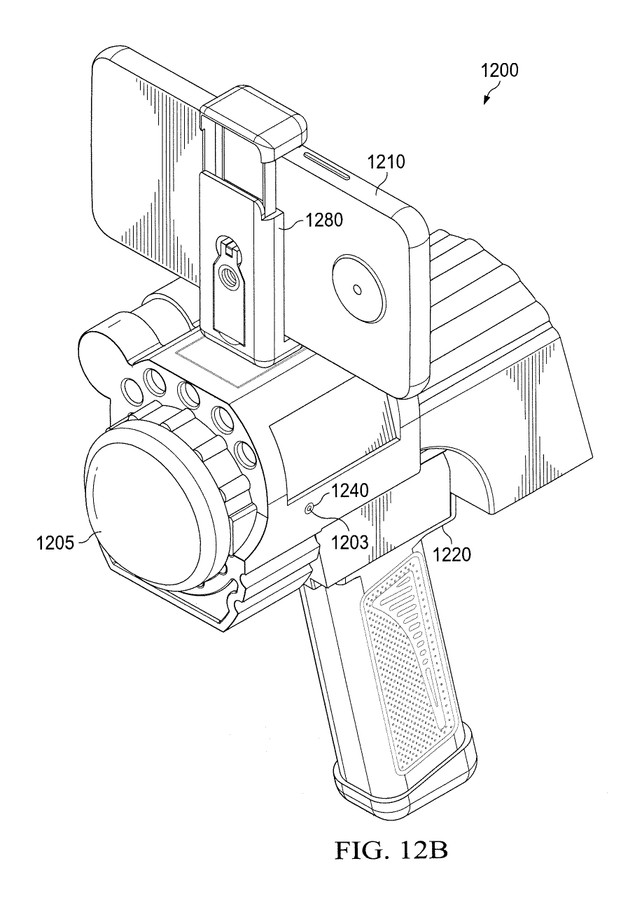

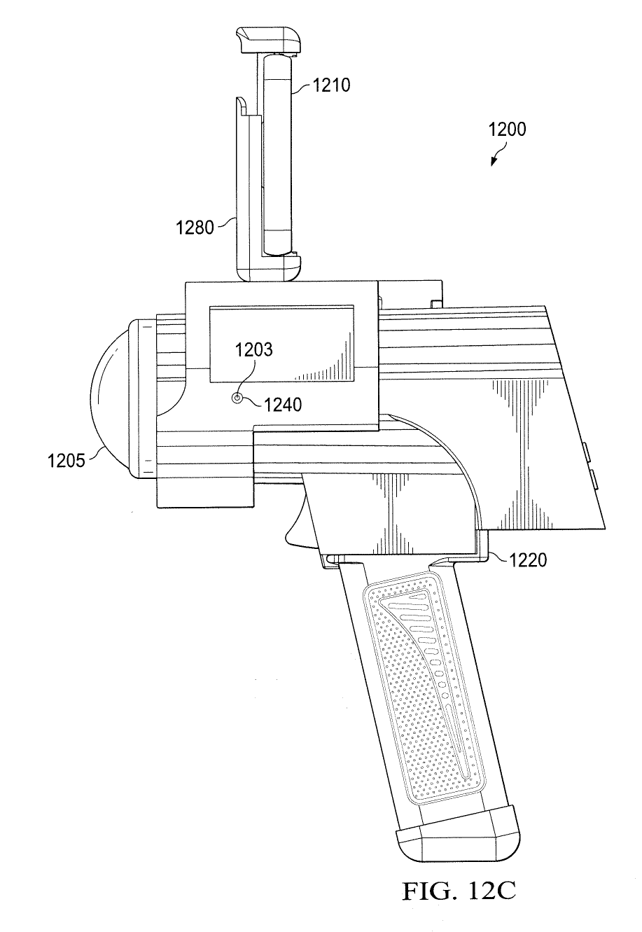

FIG. 12A is a sketch showing an exploded view of an embodiment 1200 comprising an assembly embodiment that includes a radar gun embodiment 1205 and a portable computing device embodiment 1210 comprising a camera, sleeve embodiment 1225, clamp embodiment 1280, and radar gun handle/battery embodiment 1220. For example, portable computing device embodiment 1210, like embodiment 1100, may be embodied as a cell phone (e.g., smartphone). Clamp embodiment 1280 and sleeve embodiment 1225 may collectively comprise a clamp mount embodiment, as discussed further below with respect to FIGS. 12B and 12C. Radar gun handle/battery embodiment 1220 may comprise a battery, for example, to power radar gun embodiment 1205 and/or embodiment 1210, so that power may be delivered in order for operation to take place.

During operation, a human operator may grip handle 1220 to position embodiment 1200 so that radar gun embodiment 1205 is pointed in a direction of something whose velocity is to be measured or otherwise observed, and so that embodiment 1210 is also properly positioned to capture one or more images and/or video of a scene via a camera of embodiment 1210, for example. Radar gun handle/battery embodiment 1220 may be attached to radar gun embodiment 1205, as previously mentioned, to permit power to be delivered to radar gun embodiment 1205, and in order for operation to take place and may be utilized as a handgrip for a user, for example.

Sleeve embodiment 1225 may be slid or otherwise positioned onto a cylindrical portion of a body of radar gun embodiment 1205. Sleeve embodiment 1225 may be formed of a nylon material in one particular implementation, although claimed subject matter is not limited in this respect. Other materials may be employed and provide satisfactory performance. As one example, any one of a variety of polymers may be employed. Sleeve embodiment 1225 may include a plurality of grooves 1230 on an under side which may extend along a length of a body of sleeve embodiment 1225, for example. In an embodiment, sleeve embodiment 1225 may slide onto a cylindrical portion of a body of radar gun embodiment 1205 and grooves 1230 may mate with ridges 1235 that are raised above a relatively smooth surface of radar gun embodiment 1205 so as, for example, to hinder rotational movement between sleeve embodiment 1225 and radar gun embodiment 1205. Sleeve embodiment 1225 may wrap around or otherwise envelop radar gun embodiment 1205. A bottom portion of embodiment 1225 may contain threaded and non-threaded holes to accommodate conventional tripod mounting hardware, for example.

Sleeve embodiment 1225 may include an embodiment of non-threaded hole 1240 and radar gun embodiment 1205 may include an embodiment of a threaded hole 1245. If sleeve embodiment 1225 is positioned so that 1240 and 1245 are aligned, a screw, for example, may pass the respective holes and may be threaded via 1245 to secure sleeve embodiment 1225 to radar gun embodiment 1205 and to further hinder relative movement, for example.

A top portion of sleeve embodiment 1225 may include an inset portion, such as 1260. 1260 may include one or more recesses, such as 1265. Embodiment 1265, as shown in FIG. 12A, includes two recesses, although in other implementations one or more than two recesses may be utilized and may provide at least satisfactory results. One or more plates, such as 1270, may be affixed to one or more recesses, such as 1265. In an embodiment, plates, such as 1270, may comprise metal plates. In an embodiment, as shown in FIG. 12A, respective plates, such as 1270, may be affixed to respective recesses, such as 1265, although more than one plate may be affixed to one or more recess in other implementations. A plate may be affixed to a recess by an adhesive, such as an epoxy and/or glue, for example. Likewise, a plate, such as 1270, may comprise a ferromagnetic material, such as nickel, which is capable of being attracted to a magnet, for example. However, in another embodiment metallic round-shaped washers forming a round-shaped plate may be used rather than rectangular-shaped plates. For example, steel may be employed rather than nickel. Thus, claimed subject matter is not restricted as to a particular material subject to magnetic attraction and claimed subject matter is not restricted as to shape. Likewise, in an embodiment, recesses may be formed in a manner to assist in maintaining a component in place, such as a rectangularly shaped metallic component, (e.g., plate) for example.

Sleeve embodiment 1225 may include or may otherwise secure an embodiment of an auxiliary battery or battery pack, such as 1271. For example, an auxiliary battery may be utilized as a back-up battery, for example, to provide electric power to one or more electronic components, such as radar gun embodiment 1205 and/or embodiment 1210. Auxiliary battery embodiment 1271 may comprise a lithium-ion battery pack, for example.

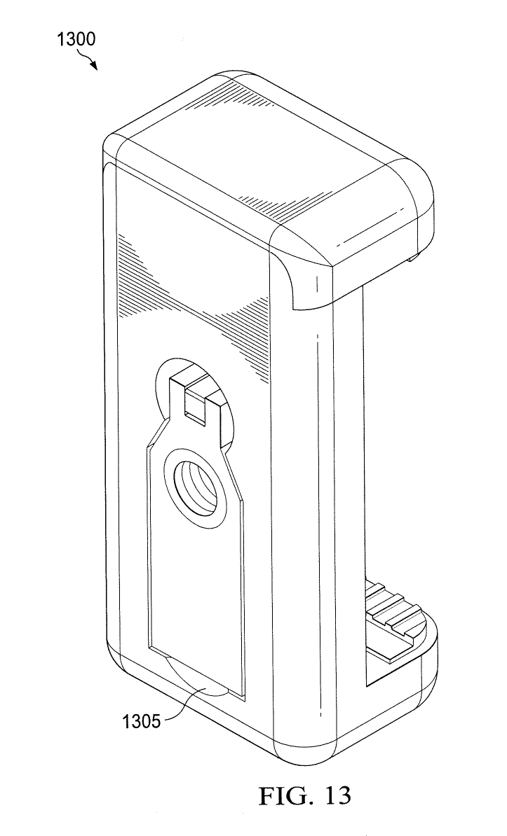

Continuing with FIG. 12A, in an embodiment, a plate embodiment 1275 may be affixed to a side of clamp embodiment 1280, such as to a bottom side. For example, a bottom side of clamp embodiment 1280 may include one or more threaded holes to receive one or more screws. Plate embodiment 1275 may include one or more magnets located on a side opposite (e.g., obverse) to a side via which plate embodiment 1275 is affixed to clamp embodiment 1280, for example. If, for example, a topside of plate embodiment 1275 is affixed to a bottom side of clamp embodiment 1280, such as via one or more screws, a bottom side of plate embodiment 1275, also referred to above as an obverse side, may include one or more magnets. For example, one or more magnets may adhere to a bottom side of plate embodiment 1275, such as via an adhesive, such as epoxy and/or glue, as examples, and/or may be attached in some further manner, such as via a screw. If plate embodiment 1275 is affixed to a bottom side of clamp embodiment 1280, plate embodiment 1275 may be placed within insert, such as 1260, of sleeve embodiment 1225, such as to detachably attach clamp embodiment 1280 to sleeve embodiment 1225 via magnetic attraction between one or more magnets of 1275 and 1270. In an embodiment, magnets of 1275 may have respective shapes similar to 1270 so as to rest flush against it for a relatively strong magnetic attraction thereto, for example. In one particular implementation, as an illustration, one or more magnets may be utilized within plate embodiment 1275 which may be rated with 12 lbs of holding capacity, although magnets of different holding capacity may likewise be utilized and provide adequate attraction. FIG. 13, as discussed in more detail below, is a diagram that shows an embodiment of a plate embodiment 1275.

FIG. 12B is a sketch of an image showing a front perspective view of embodiment 1200. FIG. 12B illustrates, for example, an assembled version of embodiment 1200, which is shown as exploded in FIG. 12A. FIG. 12C is an image showing a side view of embodiment 1200, again, after having been assembled. FIG. 12C illustrates, for example, one side of an assembled version of embodiment 1200 (e.g., the right side of embodiment 1200). As shown in FIGS. 12B and 12C, sleeve embodiment 1225 may be utilized to couple clamp embodiment 1280 to radar gun embodiment 1205. As illustrated, a screw, such as 1203, may be utilized to secure sleeve embodiment 1225 to radar gun embodiment 1205 via a threaded hole, such as 1240.

FIG. 13 is a sketch illustrating a clamp embodiment 1300, for example. Clamp embodiment 1300 may be utilized to secure an embodiment of a portable computing device, such as 1210, to a radar gun embodiment, such as discussed above with respect to FIGS. 12A-C. Clamp embodiment 1300 may be coupled to a plate embodiment, such as plate embodiment 1275, such as discussed above with respect to FIGS. 12A-C. Clamp embodiment 1300 may include a threaded portion 1305 through which a screw of a plate embodiment may be utilized to secure a clamp embodiment, such as 1300, to a radar gun embodiment.

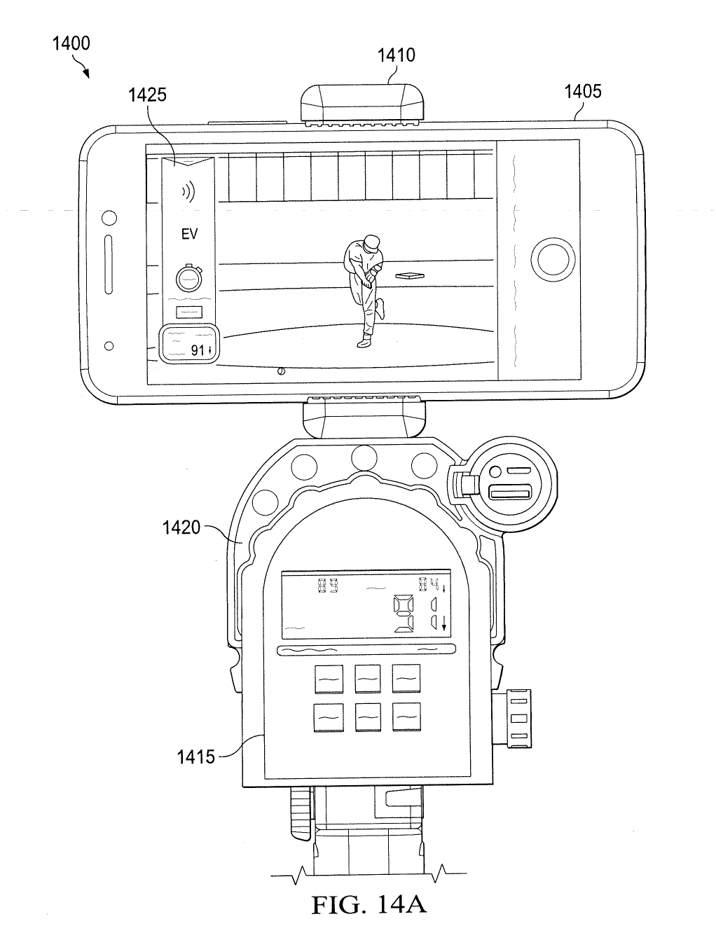

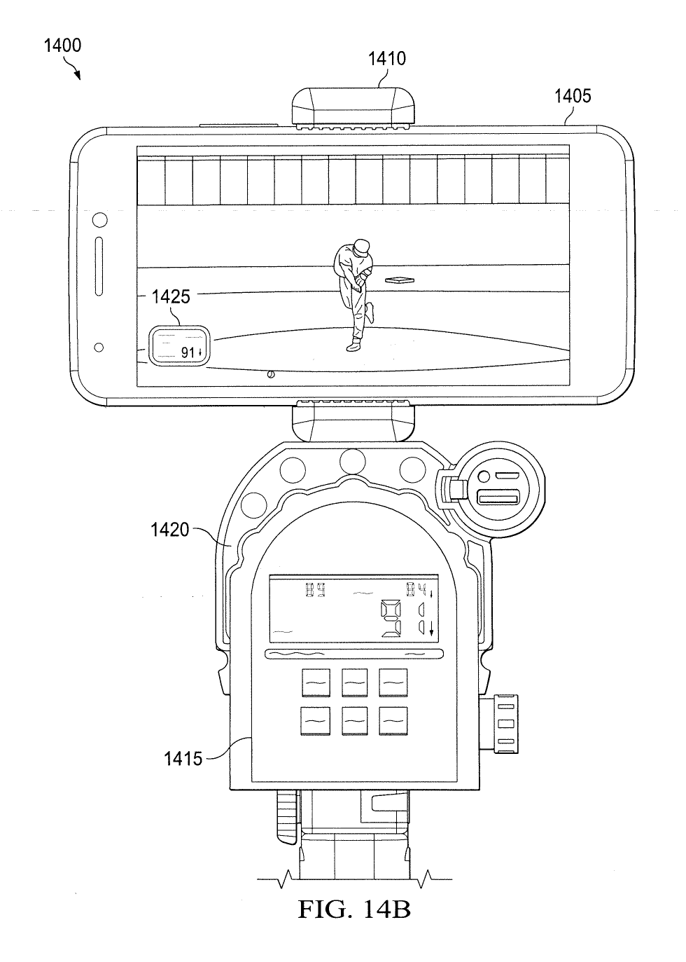

FIGS. 14A and 14B are sketches of images illustrating an assembly embodiment 1400 in which an embodiment of a portable computing device, such as 1405, may be coupled via a clamp embodiment 1410 and via a sleeve embodiment 1420 to a radar gun embodiment 1415. FIG. 14A and FIG. 14B show a scene being captured. As illustrated, embodiment 1405 may include a user interface (UI) to display composite images and/or composite video of a scene and one or more parameters. Such parameters may include a recorded time, such as for a pitched baseball to reach a particular location and/or a velocity of the pitched baseball, to name just a couple illustrative examples. As previously discussed, an embodiment, such as 1405, may execute, run, or otherwise implement an application program which includes a graphic overlay feature to generate a composite video. In FIG. 14A, for example, embodiment 1405 may display a video of a baseball pitcher throwing a baseball and graphical overlay 1425 of certain measurements obtained from radar gun embodiment 1415, for example.

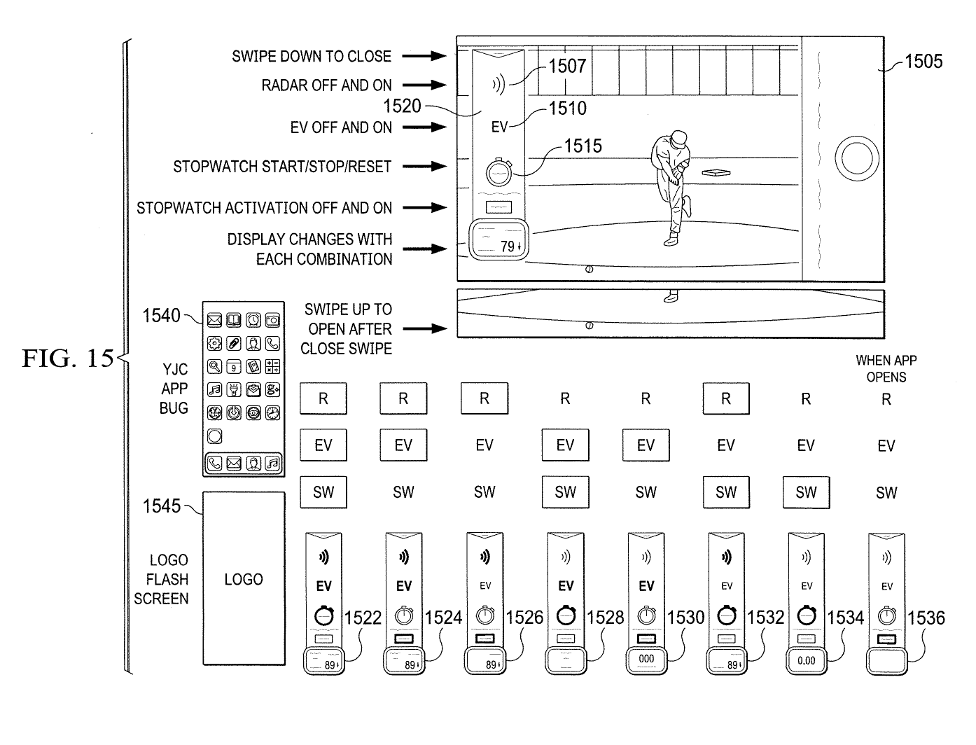

FIG. 15 is a schematic diagram of an application program to illustrate one example of icons and/or other features that might be presented on a display screen 1505 for an embodiment; although many others are possible. Thus, claimed subject matter is not intended to be limited to this simple illustrative example. Embodiment 1500 shows control buttons for various parameters and/or measurements which may be presented on display screen 1505, for example. In this illustrative example, embodiment 1500 may include a [symbol] or radar (R) button 1507, an exit velocity (EV) button 1510, and/or start/stop/reset features for a timer button 1515 in a graphical overlay 1520. Embodiment 1500 illustrates various combinations of R, EV, and SW which may be selected via one or more user input selections, such as buttons 1507, 1510, and/or 1515, to respectively control display of radar, exit velocity, and/or a timer via graphical overlay 1520, for example.

For example, if a user has selected to display parameters for R, EV, and SW, graphical overlay embodiment 1522 may be displayed on display screen 1505. If a user has selected to display parameters for R and EV, but not SW, graphical overlay embodiment 1524 may be displayed on display screen 1505. If a user has selected to display a parameter for R, but not EV or SW, graphical overlay embodiment 1526 may be displayed on display screen 1505. If a user has selected to display parameters for EV and SW, but not R, graphical overlay embodiment 1528 may be displayed on display screen 1505. If a user has selected to display parameters for EV, but not R or SW, graphical overlay embodiment 1530 may be displayed on display screen 1505. If a user has selected to display parameters for R and SW, but not EV, graphical overlay embodiment 1532 may be displayed on display screen 1505. If a user has selected to display a parameter for SW, but not for R or EV, graphical overlay embodiment 1534 may be displayed on display screen 1505. If a user has not selected to display parameters for R, EV, or SW, graphical overlay embodiment 1536 may be displayed on display screen 1505.

Thus, as illustrated, application program in accordance with embodiment 1500 may be associated with an icon to be displayed on an application icon display screen 1540 of a portable computing device, for example. If a user initiates an application program in accordance with embodiment 1500, such as by selecting a corresponding icon to be displayed on a portable computing device, for example, a logo flash screen 1545 may initially be displayed prior to displaying other features of the application program, such as those shown on display screen 1505, for an embodiment.

Thus, in an embodiment, an application program executable by an embodiment of a portable computing device, such as 1210, for example, may provide a relatively user-friendly interface, for example, to be utilized to generate a composite video of recorded images of a scene in combination with various measured parameters.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. Thus, as previously described, a parameter, such as a performance-related parameter, for example, is a term used with reference to measurements. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, measurements, as previously described, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

A wireless network may include virtually any type of now known and/or to be developed wireless communication mechanism and/or wireless communications protocol by which signals may be communicated between devices, between networks, within a network, and/or the like, including the foregoing, of course.

Example devices may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1, 2, 3 and 11 and in the text associated with the foregoing figure(s) of the present patent application.

The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 2, computing device 202 may provide one or more sources of executable computer instructions in the form physical states and/or signals (e.g., stored in memory states), for example. Computing device 202 may communicate with computing device 204 by way of a network connection, such as via network 208, for example. As previously mentioned, a connection, while physical, may not necessarily be tangible. Although computing device 204 of FIG. 2 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory may comprise any non-transitory storage mechanism. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. An apparatus comprising:
a radar gun mount to detachably attach a portable computing device that includes video imaging capability to a radar gun in a manner so that the portable computing device is able to capture a scene as radar gun measurements related to the scene are to be concurrently generated;
wherein the portable computing device is to be attached to the radar gun mount;
wherein the portable computing device and the radar gun are to be able to communicate so that the portable computing device is to be further capable to generate a composite of content formed from video imaging captured by the portable computing device and the radar gun measurements related to the scene that are to be concurrently generated.

2. The apparatus of claim 1, wherein the portable computing device includes an executable application program to generate the composite of the content.

3. The apparatus of claim 2, wherein the executable application program includes a graphic overlay feature.

4. The apparatus of claim 1, wherein the portable comprises device comprises a smartphone.

5. The apparatus of claim 1, wherein the radar gun mount comprises a clamp mount to secure the portable computing device.

6. The apparatus of claim 5, further comprising a plate having one or more magnets to be affixed to a bottom side of the clamp mount so that clamp mount is able to be detachably attached to the radar gun via magnetic attraction between the one or more magnets of the plate and one or more metallic components of the radar gun mount.

7. The apparatus of claim 6, wherein the radar gun mount comprises a sleeve to be slidable onto a portion of a body of the radar gun, and wherein the sleeve comprises the one or more metallic components.

8. The apparatus of claim 1, further comprising a connector component to couple the radar gun to a tripod.

9. A mount system comprising:
a sleeve to be slidable onto a portion of a body of a radar gun, the sleeve comprising the one or more metallic components; and
a clamp to physically couple a portable computing device to the sleeve;
wherein the portable computing device is to include video imaging capability and the portable computing device and the radar gun are to be able to communicate so that the portable computing device is to be capable to generate a composite of content formed from video imaging to be captured by the portable computing device and radar gun measurements related to the scene that are to be concurrently generated.

10. The mount system of claim 9, wherein the sleeve comprises an auxiliary battery to power the portable computing device and/or the radar gun.

11. The mount system of claim 9, wherein the portable computing device is able to execute an application program to generate the composite of the content.

12. The mount system of claim 11, wherein application program is to include a graphic overlay feature.

13. The mount system of claim 9, wherein the portable computing device is to comprise a smartphone.

14. A method comprising:
detachably attaching a sleeve onto a portion of a body of a radar gun;
physically coupling a portable computing device including video imaging capability to the sleeve via a clamp;
capturing radar gun measurements concurrently generated with and that are related to a scene captured via video imaging using the portable computing device; and
generating a composite of content formed from the video imaging captured by the portable computing device and radar gun measurements related to the scene that are concurrently generated.

15. The method of claim 14, wherein the generating the composite of the content comprises executing an application program to generate the composite of the content.

16. The method of claim 15, wherein the executing the application program includes implementing a graphic overlay feature.

17. The method of claim 16, further comprising displaying one or more parameters via the graphic overlay feature at least partially in response to one or more user input selections.

18. The method of claim 14, further comprising coupling the radar gun to a tripod.

19. The method of claim 14, further comprising coupling an auxiliary battery of the sleeve to power the portable computing device and/or the radar gun.

20. The method of claim 14, wherein the composite of content includes a presentation of a stopwatch timer.
